(19) United States
(12) Patent Application Publication
(10) Pub. No.: US 2015/0235316 A1
(43) Pub. Date: Aug. 20, 2015

(54) FACILITIES FOR FINANCIAL INSTRUMENTS BASED ON EVENT HAPPENINGS

(71) Applicant: CFPH, LLC, New York, NY (US)

(72) Inventors: Howard W. Lutnick, New York, NY (US); Philip M. Ginsberg, New York, NY (US)

(21) Appl. No.: 14/622,151

(22) Filed: Feb. 13, 2015

Related U.S. Application Data
(60) Provisional application No. 61/939,900, filed on Feb. 14, 2014.

(51) Int. Cl. G06Q 40/04

(52) U.S. Cl. CPC G06Q 40/04

(57) ABSTRACT

Various embodiments of trading in financial instruments are given. In some embodiments, a trading venue may allow trading in futures contacts that relate to the outcome of competitions, such as sporting events, television competitions, and so on.

### CROSS-REFERENCE TO RELATED APPLICATIONS

This application claims benefit of U.S. Provisional Application No. 61/939,900, filed Feb. 14, 2014 which is incorporated hereby in its entirety.

### FIELD OF THE INVENTION

Some embodiments may relate to trading of financial instruments.

### BACKGROUND OF THE INVENTION

Exchanges allow the transfer of financial instruments from one entity to another. Sporting competitions peg one or more teams against one another.

### SUMMARY OF THE INVENTION

The following should be understood as embodiments and not as claims.

A. A method comprising: receiving, by a computing device, information defining a winning parameter of a contest from a contest expert; listing, by the computing device, a financial instrument that gives a holder of the financial instrument a right to a payment based on an outcome the contest and the winning parameter; receiving, by the computing device, an offer to sell the financial instrument at a first price; receiving, by the computing device, a bid to buy the financial instrument at the first price; matching, by the computing device and in response to receiving the bid for the first price and receiving the offer for the first price, the offer and the bid; and facilitating, by the computing device and in response to matching the bid and the offer, a trade that fulfills at last a part of each of the bid and the offer.

A.1. The method of claim A, in which the contest includes a fantasy sports game. A.2. The method of claim A, in which the computing device includes an electronic marketplace. A.3. The method of claim A, in which facilitating the trade includes controlling a clearinghouse to make the trade. A.4. The method of claim A, in which the method comprises: determining, by a second computing device, the matching bid and offer for the financial instrument; facilitating, by the second computing device and in response to determining the matching bid and offer, a transfer of money from the second user's account into the first user's account; forming, by the second computing device and in response to determining the matching bid and offer, a first obligation to make a payment of an amount of money to the second user if the outcome of the contest meets the winning parameter; forming, by the second computing device and in response to determining the matching bid and offer, a second obligation to receive a payment of the amount of money from the first user if the outcome meets the winning parameter; determining, by the second computing device, that the outcome meets the winning parameter; facilitating, by the second computing device and in response to the determining that the outcome meets the winning parameter, a payment of the amount of money to the second user; and facilitating, by the second computing device and in response to the determining that the outcome meets the winning parameter, a payment of the amount of money from the first user. A.5. The method of claim A, in which the winning parameter includes a line.

B. A method comprising: determining, by a computing device, a matching bid and offer for a financial instrument; facilitating, by the computing device and in response to determining the matching bid and offer, a transfer of money from a second user's account into a first user's account; forming, by the computing device and in response to determining the matching bid and offer, a first obligation to make a payment of an amount of money to the second user if the outcome of a contest meets a winning parameter set by an expert; forming, by the computing device and in response to determining the matching bid and offer, a second obligation to receive a payment of the amount of money from the first user if the outcome meets the winning parameter; determining, by the computing device, that the outcome meets the winning parameter; facilitating, by the computing device and in response to the determining that the outcome meets the winning parameter, a payment of the amount of money to the second user; and facilitating, by the computing device and in response to the determining that the outcome meets the winning parameter, a payment of the amount of money from the first user.

B.1. The method of claim B, in which the computing device includes an electronic clearing house.

B.2. The method of claim B, in which the contest includes a fantasy sports game.

B.3. The method of claim B, in which the winning parameter includes a line.

B.4. The method of claim B, in which determining the matching bid and offer includes receiving the matching bid and offer from an electronic marketplace.

B.5. The method of claim B, in which the method comprises:
receiving, by a second computing device, information defining the winning parameter of the contest from the contest expert;
listing, by the second computing device, the financial instrument, in which the financial instrument gives a holder of the financial instrument a right to a payment based on an outcome the contest and the winning parameter;
receiving, by the second computing device, an offer to sell the financial instrument at a first price;
receiving, by the second computing device, a bid to buy the financial instrument at the first price;
matching, by the second computing device and in response to receiving the bid for the first price and receiving the offer for the first price, the offer and the bid; and
facilitating, by the computing device and in response to matching the bid and the offer, a trade that fulfills at last a part of each of the bid and the offer.

C. An apparatus comprising: a computing device and a non-transitory medium having stored thereon a plurality of instructions that when executed by the computing device cause the apparatus to:
receive information defining a winning parameter of a contest from a contest expert;
list a financial instrument that gives a holder of the financial instrument a right to a payment based on an outcome the contest and the winning parameter;
receive an offer to sell the financial instrument at a first price;
receive a bid to buy the financial instrument at the first price;
match, in response to receiving the bid for the first price and receiving the offer for the first price, the offer and the bid; and
facilitate, in response to matching the bid and the offer, a trade that fulfills at last a part of each of the bid and the offer.

D. An apparatus comprising: a computing device and a non-transitory medium having stored thereon a plurality of instructions that when executed by the computing device cause the apparatus to:
determine a matching bid and offer for a financial instrument;
facilitate, in response to determining the matching bid and offer, a transfer of money from a second user's account into a first user's account;
form, in response to determining the matching bid and offer, a first obligation to make a payment of an amount of money to the second user if the outcome of a contest meets a winning parameter set by an expert;
form, in response to determining the matching bid and offer, a second obligation to receive a payment of the amount of money from the first user if the outcome meets the winning parameter;
determine that the outcome meets the winning parameter;
facilitate, in response to the determining that the outcome meets the winning parameter, a payment of the amount of money to the second user; and
facilitating, by the computing device and in response to the determining that the outcome meets the winning parameter, a payment of the amount of money from the first user.

### BRIEF DESCRIPTION OF FIGURES

FIG. 1 illustrates an example system that may be used in some embodiments.

FIG. 2 illustrates an example process that may be used in some embodiments.

FIG. 3 illustrates an example process that may be used in some embodiments.

### DETAILED DESCRIPTION

Financial instruments may be traded through a trading apparatus. A trading apparatus may facilitate matching, exchange, settlement, tracking, calculating and/or other actions that may aid in the establishment of a market for the financial instruments. Traditional financial instruments come in the forms of equity and debt instruments. More recent innovation in the trading of financial instruments has brought about a market for derivative instruments such as futures and/or options.

In some embodiments, a trading apparatus may facilitate trading in a financial instrument that is defined in some manner by the happenings in one or more events (e.g., competitions). A trading apparatus may list a financial instrument for trading, may facilitate matching of bids and offers for such a financial instrument, may facilitate a formation of such a financial instrument, may facilitate a trade of such a financial instrument, may facilitate settlement of such a financial instrument, and/or may take any desired actions that relate to such a financial instrument.

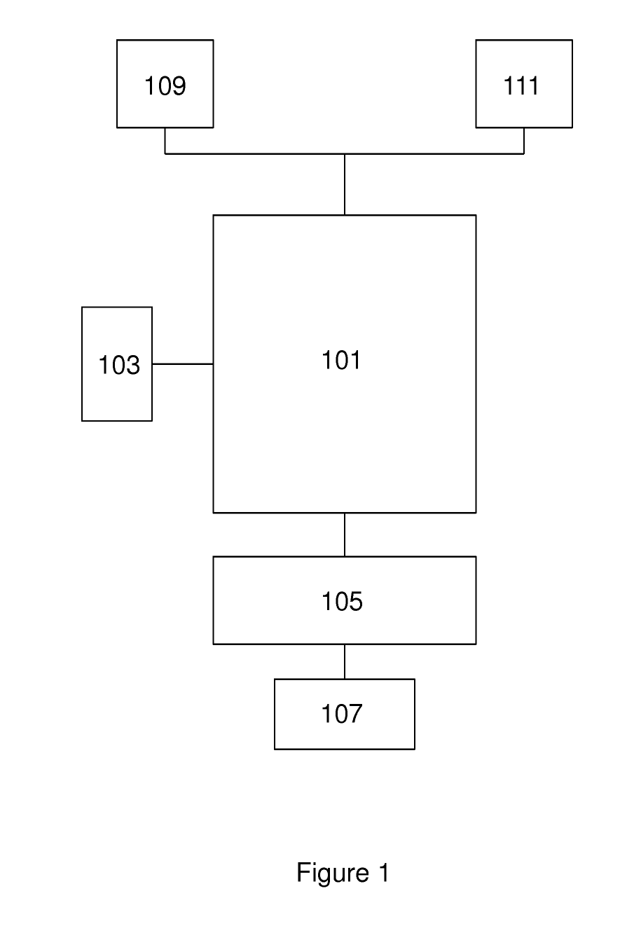

FIG. 1 illustrates an example trading apparatus 100 that may be part of some embodiments. It should be recognized that this trading apparatus is given as a non-limiting example only and that other embodiments may include any desired structure. The example trading apparatus includes an electronic marketplace 101, a contest expert 103, an electronic clearinghouse 105, a contest information source 107, a first user device 109, and a second user device 111. Such an apparatus and/or one or more components thereof may be referred to as an exchange, a matching venue, a trading facility and so on.

Electronic marketplace 101 may manage bids and offers for financial instruments. The marketplace may receive bids, receive offers, list financial instruments for trading, communicate with experts regarding lines or other parameters, match bids and offers, initiate requests for cross, determine listing parameters such as times, offloading responsibility to a clearinghouse, and so on. Such actions may be performed by one or more computing devices, such as servers, that make up the marketplace. Such actions may take place periodically, on demand, in response to events happening, and so on.

For example, a first user may submit a bid to purchase a financial instrument to the marketplace. A second user may submit an offer to sell the financial instrument to the marketplace. Any number of bids and offers may be received for any number of financial instruments from any number of users. The marketplace may match the bids and offers together to form trades between users. Processors and/or queues may be used in some embodiments to manage and track the variety of orders for a variety of financial instruments that may trade through a marketplace.

The electronic marketplace may match bids and offers for a financial instrument in a variety of manners. For example, in some embodiments, a pro-rata filling mode may be used in which one bid or offer may be matched against a plurality of matching offers or bids in a pro-rata manner. As another example, a first come first serve mode may be used in which an incoming bid or offer is matched against a matching offer or bid that has been pending for a longest amount of time first. Offers and bids may be determined to be matching based on being for a same financial instrument and for a same price or price mechanism. In response to finding matches, a marketplace may communicate with a clearinghouse to facilitate an exchange to fulfil the matching orders. Matching orders may happen in a high speed environment to minimize latency or delay so that accurate pricing and desire matching takes place. This can be accomplished using state of the art computing and/or networking technologies.

An electronic marketplace may initially list a financial instrument for trading. Listing of such an instrument may include publicizing information about the financial instrument (e.g., line data, information about how a value of the instrument is determined, and so on). For example, a point spread in an upcoming football game may be determined using information from an expert. The point spread and game may be published as a parameter of the financial instrument when it is listed by the marketplace for trading so that users know the parameters of the financial instrument and how or when it might cause a payment to be made.

An electronic marketplace may publish information about bids, offers, and trades. For example, an order book may maintain trading information and make that information public for users to view. Users may be able to view a number of orders on each side of a financial instrument, prices for those orders, completed trades for a financial instrument, and so on.

Some non-limiting example financial instruments that may be traded through such a marketplace may include: a financial instrument that pays a holder if team A beats team B in a designated contest (by more than a line in some implementations), a financial instrument that pays a holder if a quarterback throws more than another quarterback in a set of contests, a financial instrument that pays a holder if a fantasy team (of 1 or more players) scores more fantasy points define by some equation over the course of some contests than some target points, a financial instrument that pays a holder if a player in a position achieves more fantasy points than one or more other players in that position over one or more games, a financial instrument that pays a holder if a participant takes as designated place in a contest (e.g., wins, gets second or better place, makes it to a final round), a financial instrument that pays a holder if a player does not play in a contest (e.g., because of injury), a financial instrument that pays a player if a particular situation exists during the play of a contest (e.g., it rains, it is colder than a threshold temperature, an injury occurs to a player, etc.), and so on. A par value of an instrument may be paid to the holder if an obligation-triggering event occurs. A buyer of such an instrument may pay a price to a seller to hold that financial instrument. It should be recognized that these examples are given as non-limiting examples only and that any desired financial instrument may be used in an embodiment. For example, any desired financial instrument that depends on events or situations in one or more future events, such as live contests, may be used.

A user may combine one or more such financial instruments into a portfolio to achieve interesting results. For example, a user may buy a financial instrument that team A will beat team B in a game. The user may also buy an instrument that team A's offense will perform worse than team B's offense. In such a situation, the user may effectively be guessing that team A will win the game even though their offense will not be the better offence (e.g., they may be hoping that defense will carry team A). As another example, a user may select a team to win a game and may buy another instrument that pays if a weather pattern occurs at the game. In that case, the user may have hedged against the risk that a team that is bad in that weather condition will win, but the user may still win if the weather pattern happens and the team loses because of the hedging option. As still another example, a user may select a set of instruments that each pit one player against another player in fantasy points. Effectively, then the player has selected a fantasy team A and fantasy team B to play against one another.

Contest expert 103 may determine line information or other contest or event related information that may be used to define terms of a financial instrument. Information may be received from a source of contest information (e.g., the NFL.com, a line maker, a news site, etc.). For example, players in a contest, teams in a contest, statistical information of participants in a contest, weather on a contest day, injury information, and son may be received. For example, if a contest is a sporting event, a sporting event data source such as the NFL or MLB may provide information about the sporting event. If the contests is a television contest, then a television network may report information about the contest.

Such information may be used by the expert to determine appropriate parameters for a financial instrument based on a contest. For example a determination may be made that based on historical statistics, Team A is likely to beat Team B by 5 points in a contest. That information may be transmitted to the marketplace for use in defining a financial instrument based on the game. For example, the financial instrument may be established so that the holder of the instrument is due a payment if team A beats Team B by the number of points or more. Parameters may include such things as expected scores, expected fantasy points, expected point differences, and so on.

As another example, an expert may determine likely fantasy points that each of a set of fantasy teams may score. A marketplace may use that information to list a set of financial instruments for those fantasy teams. For example, a fantasy team may be expected by the expert to earn 15 fantasy points over a game period (e.g., a weekend). A financial marketplace may list a financial instrument that pays a holder a par value if the team earns that many points. A set of such instruments may be listed with a variety of fantasy teams.

An expert may make ongoing determinations of such parameters. For example, as more data is received, the expected scores may change. For example, if an injury occurs to a star player, then the expected points may change. A marketplace may deal with such changing parameters in a variety of manners.

In some embodiments, a financial instrument may be defined by a last parameter determination. In such a situation, a user may purchase a financial instrument while the parameters are set in one level but that level may change as time goes on so that the user may not be sure of the parameter level until a final setting of that level occurs (e.g., at a time of the start of a game for instance). Such changing may not be allowed in some marketplaces.

As another example, a marketplace may make a new listing in response to a change in a parameter. Accordingly, there may be multiple listings of financial instrument for a same game with different parameters. A ticker symbol may identify the parameter so that users may know what they are bidding or offering for. For example, a symbol may indicate TEAMA_TEAMB_GAMEDATE_LINE. The line may be a positive or negative number indicating how many more points team A will earn than team B.

In still other embodiments, a marketplace may list a variety of instruments with varying parameters for a contest without regard for an expert and/or that different from an expert. For example, a marketplace may list many different instruments with many different lines. As another example, a marketplace my list instruments in response to requests from users (e.g., a person may identify a games and/or teams and a desired line, and in response, a marketplace may make such a listing available for trading).

Because financial instruments may trade based on the parameters determined by such an expert, there may be pressure on the expert to accurately predict the outcome of an event. To achieve this goal, the expert may engage complicate statistical algorithms based on a large data set to determine an expected outcome with as much accuracy as possible.

An expert may include any computing device, algorithm, person, and so on in any combination that may generate, collect, assemble, and/or determine information that may be used to determine parameters for a financial instrument and/or may actually determine the parameters themselves. Although illustrated in this example embodiment as separate from the marketplace 101, in some embodiments, an expert and a marketplace may be a same entity.

Clearinghouse 105 may act to clear matched bids and offers from a marketplace. A clearinghouse may take actions to facilitate the fulfillment of terms in a financial instrument. A clearing house may include one or more computing devices in communication with one or more marketplace, one or more users, one or more information sources and/or any other components.

As an example, the clearinghouse may receive information from the marketplace indicating a matching bid and offer for a financial instrument. The clearinghouse may act to facilitate the exchange of the financial instrument between a user that submitted the bid to the marketplace and a second user that submitted the offer to the marketplace.

For example, the clearinghouse may in some embodiments, take possession of both an amount of money from a first user and the financial instrument from a second user. The clearinghouse may then transfer ownership of the money from itself to the second user and the financial instrument to the first user. Accordingly, the clearinghouse may have facilitated transfer of the financial instrument through itself from one user to another and money through itself from one user to another. Such a transfer mechanism may be well suited, for example, for instrument such as debt or equity instruments.

As another example, the clearinghouse may in some embodiments, enter into obligations with a user and a second user. For example, a futures contract may take a form in which party B will owe party A if team A wins a game. Party A may show interest in buying such a futures contract through the marketplace for some amount of money by placing a bid on the marketplace. Party B may show interest in selling such a futures contract by submitting an offer to sell the futures contract to the marketplace. Upon matching the bid and the offer, the marketplace may notify the clearinghouse of the match. In response, the clearinghouse may accept money from party A and enter into an agreement whereby the clearinghouse agrees to pay party A if team A wins the game. And, the clearinghouse will enter into an offsetting transaction with party B, whereby the clearinghouse will pay party B the same amount of money as it accepted from party A and will enter into an obligation with party B to accept a payment if team A wins the game.

In this scenario, the clearinghouse stands in the middle of party A and party B with minimized risk because of the offsetting transactions. Although examples may be given in terms of offsetting transfers through a middleman, in some embodiments, those transfers may only be theoretical (e.g., if an offsetting transaction through a clearinghouse is to occur, then rather than occurring in constituent parties, it may occur in aggregate so that, for example, a transfer may be made from party B to party A directly rather than first a transfer to the clearinghouse being made and then a transfer from the clearing house being made). The parties are relieved of counterparty risk is they can trust the clearinghouse. Such a transfer mechanism may be well suited, for example, for trading in derivative instruments such as futures contracts.

It should be recognized that these example transfer mechanisms are given as non-limiting examples only. Other embodiments may include any desired mechanisms that may be performed by a clearinghouse, marketplace and/or other entity as desired. For example, some embodiments may not include an amount of money transferred until an end of a contract term, some embodiments may include requiring party B to have an amount on hold with a clearinghouse in reserve in case an obligation to pay occurs (e.g., an amount equal to a par value, etc.), some embodiments may include keeping a bid payment on hold until an event is concluded and requiring a bid-par value amount to also be put on deposit by an offering party, and so on. As another example, some embodiments may not use a clearinghouse as a middleman but rather may transfer contracts directly between parties. Various elements of such actions may take place at a clearinghouse and/or a marketplace as desired. For example, as discussed below, a marketplace may maintain accounts for users and a clearing house may only have access to that money through the marketplace. Accordingly, a marketplace may keep money on hold or frozen to hedge risk when an obligation may require a payment, and a clearinghouse may direct a marketplace to adjust account balances to fulfil obligations.

In some embodiments, a clearinghouse may have ongoing responsibility to facilitate fulfillment of obligations embodied in a traded financial instrument. For example, a clearinghouse may be required to make a payment and/or take a payment from one or more parties to a futures contract that the clearinghouse helped transfer. The clearinghouse may accept information from an information source 107 that identifies the outcome of an event. Based on that information, the clearinghouse may determine what obligations are triggered from financial instruments that it tracks (e.g., instruments for which it is a middleman). In response, the clearinghouse may cause any obligated money transfers to occur based on the event results (e.g., by adjusting an account balance such as by directly adjusting a balance it controls and/or by directing a marketplace to make a balance adjustment).

For example, in the given example of party A and party B trading a futures contract, the clearinghouse may determine that team A wins the game. In response, the clearinghouse may determine that the clearing house owes party A and is owed from party B. The clearinghouse may transfer money from party B to the clearinghouse and from the clearinghouse to party A in response (e.g., by directing a marketplace to make such transfers.). In some embodiments, two transfers may not be used because they are offsetting to one another. Rather, a single transfer from party B to party A may be used.

As another example, if the parties themselves have direct agreements with one another without the clearinghouse standing in the middle, the clearinghouse may similarly facilitate completion of an obligation. For example, the clearinghouse may determine an event outcome and what obligations that outcome triggers. The clearinghouse may then make those obligations occur (e.g., transfer money from an account of party B to an account of party A in response to team a winning).

In some embodiments, if information is determined that an event is canceled or some other cancelation event occurs (e.g., the information source tells the clearinghouse than an event is cancelled, a player in a fantasy team does not play, etc.), the clearinghouse may take an action to cancel a financial instrument in response. For example, the clearinghouse may return transferred money (possibly excluding a commission) to/from parties. The clearinghouse may also cancel any ongoing obligations that may have been entered into as a result of a trade.

It should be recognized that examples of a clearinghouse facilitating fulfillment of ongoing obligations are given as non-limiting examples only. Other embodiments may include other actions, other responses to cancelation events (e.g., a default winner), and/or no clearinghouse involvement at all (e.g., another entity may take actions, the marketplace may take actions such as determining obligations triggered, the parties themselves may be responsible for actions, and so on).

A marketplace and/or clearinghouse may take a commission at some point along the process. For example, a portion of an amount of money collected and/or eventually owed from one party to another may not actually be given to another party. Rather some portion of that amount of money may be collected as a commission. So, when a discussion of an amount being transferred from party B's account to party A's account is discussed it should be understood that the amount transferred from and to may differ by some commission amount collected for the services provided. This similarly may apply to an amount of money bid/offered being transferred.

Information source 107 may include a source of information that may be used to determine outcomes of events. Such information may be used by a marketplace, clearinghouse, and/or other entity to determine an obligation of a party to a financial instrument. As discussed above, for example, if a team wins a game, which may trigger a payment being made from one party to another party, the information that the team won the game may be sourced from the information source. Such a source, for example, may include a news source, a website, the NFL, the MLB, a TV station, an official league source, a third party auditing system, and so on. Such a source may include a source that may be used to determine expert information by an expert and/or may be a different source. An information source may determine an outcome of an event and may publish that information. That information may be pushed from the source or pulled from the source, for example, through an API. The source may include one or more computing devices that receives and/or determines information about events and makes that information available.

Users 109 and 111 may include users that may place bids and/or offers through marketplace 101 to engage in trading of financial instruments. The users may use computing devices to place orders through a network using a user interface and/or API of a marketplace. For example, user 109 may submit a bid order (e.g., may be party A described above) and user 111 may submit an offer order (e.g., may be party B described above). As described above, the orders may be matched and obligations may be triggered.

Users may maintain accounts through which trading may originate. An account may be maintained with a marketplace for each user. The user may authenticate with a marketplace to gain access to the account. Users may transfer money in and out of such an account and/or use that money to engage in trading. Accounts maintained in such a way may also be a source of money to pay obligations and/or to receive payments as a result of obligations being met (e.g., money that party B may owe party A may be taken out of party B's account and deposited into party A's account or similarly transferred with a clearinghouse as a middleman). In some embodiments, a clearinghouse and marketplace may communicate to facilitate such transfers among accounts (e.g., a clearinghouse may notify the marketplace to make a transfer and a marketplace may make the transfer in response and notify the clearinghouse of completion). In some embodiments, a marketplace may transfer money to a clearinghouse for the clearinghouse to hold until an obligation is resolved and then the clearinghouse may transfer it back to the marketplace with a direction as to where to deposit it. In some embodiment, a marketplace may transfer money to a clearinghouse to settle a bid and offer (e.g., money from party A's account). The clearinghouse ma return the money to the marketplace with a direction as to where to deposit the money (e.g., into party B's account).

In other embodiments, an account may be maintained at a clearinghouse rather than with a marketplace for each user. Accordingly, the clearinghouse may have direct access to account transfers. The clearinghouse may notify the marketplace of balances in some embodiments, may take direct for transfer between such accounts, and so on.

In some embodiments, a marketplace may use an account balance to determine eligibility for trading. For example, a user may be required to have some amount of a balance before a trade can occur. For example, a user may be required to have an amount of money to make a payment for a bid to purchase a financial instrument in an account before the user can place a bid order. The money to make such a payment may be frozen in an account while such an order is pending. A marketplace and/or clearinghouse may communicate with one another to freeze such money depending on who maintains an account. (e.g., a marketplace may receive an order, determine a balance in a clearinghouse account and communicate to the clearinghouse that some amount of money should be frozen for the order or a marketplace may maintain the account and freeze the money in the account). Frozen money may be removed from an account and/or stay in an account but be ineligible for use in trading or withdrawing except as to the trade that is pending and resulted in the freezing.

A risk management module operated by a marketplace and/or clearinghouse may track risks and adjust account abilities based on that risk. For example, as funds are frozen because they are used to place orders, a risk management module may track available funds for trading. Those funds may be compared to new trading requests to determine if a user is eligible to place an order. If a user has enough available funds for the order, the user may be allowed to place the order. If not, the user may be prevented from placing the order and notified of the deficiency. Communication between such a module and a marketplace and/or clearinghouse may be used to track the availability of funds (e.g., amount user has deposited pending orders in the marketplace, completed orders through the clearinghouse, etc. may be tracked to determine available funds).

In some embodiments, a trade may form a possible ongoing obligation (e.g., in the example of a futures trade based on a game above party B may owe party A if team A wins). This future obligation may be an amount of money that may be due based on the outcome of an event. A risk management module may count the possible amount that may be owed as a frozen amount of money that is not available for trading. Similarly, the risk management module may count that amount as risk so that a trade may only be allowed if there is enough money in an account to make that possible payment in the event that the obligation becomes due. Using such a restriction a system may guarantee that a party has funds to fulfill any obligation that may arise. In some embodiments, when a clearinghouse determines that a possible obligation comes to an end (e.g., is canceled or otherwise an event outcome is determined), a money transfer may or may not happen and any frozen funds related to that obligation may be unfrozen. Such risk management may be tracked by any combination of clearinghouse actions, user account deposits or withdraws, marketplace actions and/or communications about such actions.

In some embodiments, a clearinghouse may hold funds that may be needed to pay obligations. In some embodiments, a marketplace may put such funds in a user's account (with or without restrictions until the obligation is resolved). In some embodiments, a clearinghouse may hold funds that are paid to buy a financial instrument until obligations that may arise are resolved. In some embodiments, a marketplace may put such funds in a user's account (with or without restrictions on use until the obligation is resolved).

For example, in the example trade above money may be moved, possibly through the clearinghouse, from party A to party B for a bid payment. If team A wins, money may be moved, possibly through the clearinghouse, from party B to party A. The money that has the possibility of being moved based on team A winning, may be held as collateral in party B's account and not usable for trading while that obligation is outstanding. That money may be held elsewhere or treated differently in other embodiments.

Such examples of risk management are given as non-limiting examples only. Other embodiments may not include such risk management, may include margin abilities, may include a third party accounting system and/or risk system, may include separate accounts at a clearinghouse and a marketplace (e.g., an account that must have accounts in the marketplace to pay a bid fee and an account tin a clearinghouse that must have sufficient funds to cover obligations) and/or may include other methods of managing risk.

Elements of FIG. 1 may communicate with one another. For example, a communication network such a LAN or the Internet may connect elements to one another and allow for electronic communication among elements. For example, order information may be transmitted from users to a marketplace, trade information and/or risk information may be communicated between a marketplace and a clearinghouse, and so on.

It should be recognized that the examples of FIG. 1 are given as non-limiting examples only. Other embodiments may include any desired combination of entities that may perform any desired combination of actions to facilitate trading of financial instruments.

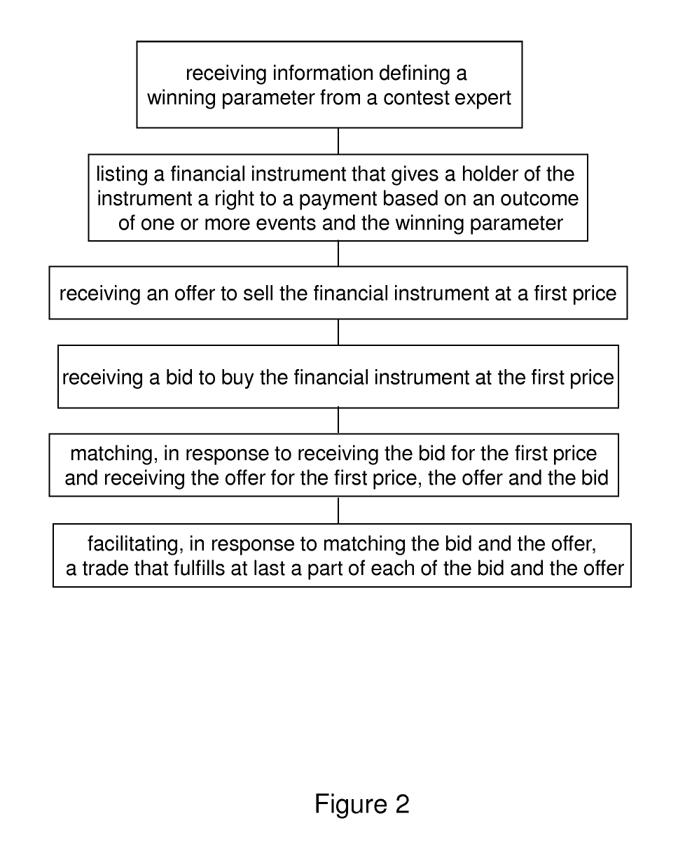

FIG. 2 illustrates an example process that may be performed in some embodiments. Such a process may be performed by one or more elements of a trading apparatus. For example, such a process may be performed by an electronic marketplace 101. Such a process may facilitate trading in financial instruments.

As indicated, some embodiments may include receiving information defining a winning parameter from a contest expert. Such information may be received from an expert such as the one described above. Such information may, for example, include a line for a contest (e.g., participant A will win the contest by at least the line amount based on the expert calculation). As another example, such information may include an expectation of results for one or more participants in an event (e.g., a fantasy team will score X number of fantasy points in a competition period). It should be recognized that these examples of information that may be used to define a winning parameter are non-limiting examples only. In some embodiments, such information may be determined based on statistical information and/or expert information in any combination. Any information used to set a parameter for a listing may be received from any number of sources through any desired means.

As indicated, some embodiments may include, listing a financial instrument that gives a holder of the instrument a right to a payment based on an outcome of one or more events and the winning parameter. A winning parameter may include a parameter that defines what is a winning outcome and what is not a winning outcome. For example, in some embodiments, information may be received from an expert that may define or may be used to define a line for a sporting event or other contest. A marketplace may use that information to define a financial instrument's possible future obligations. A financial instrument may be made public and trading may be allowed (e.g., information may be published in an order book, a marketplace may list a ticker symbol, a marketplace may begin to take orders, etc.). The financial instrument may obligate a payment to a holder if an outcome of the sporting event meets the wining parameter. (e.g., if team A beats team B in the game by at least a line, if a fantasy team earns at least an amount of fantasy points in a game, etc.). Each financial instrument may have some par value (e.g., $1, $10, $100, $1000, $10000, etc.). The par value may indicate the amount of money that the holder of the instrument may be due if the wining parameter is satisfied. For example, an instrument may be listed that would obligate the holder $100 if team A beats team B in a game. The par value may differ from instrument to instrument (e.g., baseball may have a different par value form football) or be the same from instrument to instrument.

As indicated, some embodiments may include, receiving an offer to sell the financial instrument at a first price. An offer may be defined by a quantity of financial instruments (e.g., 10 instruments that have a par value of $100 for a possible loss of $1000) and a price for each of those instruments (e.g., $90 for each instrument). For example, a computing device may present a trading interface to a first user. The user may enter information into the trading interface (e.g., price at which they are willing to sell, number of instruments they are looking to sell, etc.). In some embodiments, instruments may be sold in whole units. In other embodiments, instruments may be sold in fractional units. A user may actuate one or more controls to cause a computing device to transmit order information to the marketplace. The marketplace may receive information defining the offer. In response, the marketplace may add such an offer to an order book and/or otherwise process the order for matching. A marketplace may receive any number of offers to sell any number of financial instruments at any number of prices.

As indicated, some embodiments may include, receiving a bid to buy the financial instrument at the first price. A bid may be defined by a quantity of financial instruments (e.g., 10 instruments that have a par value of $100 for a possible win of $1000) and a price for each of those instruments (e.g., $90 for each instrument). For example, a computing device may present a trading interface to a second user. The user may enter information into the trading interface (e.g., price at which they are willing to buy, number of instruments they are looking to buy, etc.). In some embodiments, instruments may be bought in whole units. In other embodiments, instruments may be bought in fractional units. A user may actuate one or more controls to cause a computing device to transmit order information to the marketplace. The marketplace may receive information defining the bid. In response, the marketplace may add such a bid to an order book and/or otherwise process the order for matching. A marketplace may receive any number of offers to buy any number of financial instruments at any number of prices.

As indicated, some embodiments may include, matching, in response to receiving the bid for the first price and receiving the offer for the first price, the offer and the bid. Orders for opposite sides of a trade of a same financial instrument at a same price may be considered to match. For example, an offer to sell a first quantity of financial instruments at $90 and a bid to buy a second quantity of the financial instrument at $90 would be considered matching orders in some embodiments. A matching engine of an exchange may be responsible for matching bids and offers on an continuous, periodic, occasional, and so on basis as desired. Such a matching engine may compare bids and offers pending for any number of financial instruments in an order book of the marketplace to determine if there are any matching orders.

Offers and bids may be received in any order in any number and combination. Such orders may be placed in an order book of pending orders on the marketplace. Matching may occur as such orders are received. Such matching may include FIFO, pro-rata, price and time priority, and so on matching.

Orders may take a variety of types. For example, some orders be allowed to be matched in part while other orders may be allowed to be matched only in whole. For example, a bid to buy 100 contracts may be matched against an offer to sell 100 contract. Some orders may specify that they may only match in full like in that example. As another example, a bid to buy 100 contracts may be matched against an offer to sell 90 contracts. Ten unbought contracts may remain in the bid. That unfilled bid portion may be canceled and/or may remain pending depending on an implementation. If the order portion remains pending, it may be matched against another offer (e.g., an offer to sell 10 contracts or some other amount of contracts).

As indicated, some embodiments may include, facilitating, in response to matching the bid and the offer, a trade that fulfills at last a part of each of the bid and the offer. For example, a marketplace may transmit information and/or money to a clearinghouse to execute a trade and/or a marketplace itself may cause a trade to be executed. As discussed above, a marketplace may transfer money from a bidders account to cover a cost of the purchase of an amount of the financial instruments to a clearinghouse. The marketplace may also indicate that the offer and bid have been matched and that an exchange should take place.

As a non-limiting example, a user A's bid to buy 100 contracts for 90 dollars each may be matched against user B's offer to sell 100 contracts for 90 dollars. The marketplace may transfer 9000 dollars from user A's account to the clearinghouse and indicate that a trade fulfilling the offer and bid should be executed. That execution may take place in many forms depending on implementation. For example, the clearinghouse may act as a middleman and/or the parties may directly trade with one another. Various examples of executing a trade are given herein.

In some embodiments, rather than a clearinghouse, a marketplace may execute the trade. The marketplace may similarly act as a middle man or net depending on the implementation. A middleman helps to eliminate counter party risk as discussed elsewhere.

In a middleman clearinghouse embodiment, at the end of the facilitation, the clearinghouse may have offsetting obligations with each of party A and party B as discussed elsewhere. Also, the clearinghouse may return the 9000 dollars to the marketplace with direction to place it in user B's account (some commission may be taken out). In other embodiments, that money may be held to offset risk or be otherwise frozen by a clearinghouse and/or marketplace.

Although not indicated in the figure, some embodiments may include opening and/or maintaining accounts for users. Such actions may be taken by the exchange. Money may be deposited, withdrawn, used, and/or transferred. For example, user A may deposit money into an account and use that money to purchase financial instruments. User B may similarly deposit money and use that money to purchase instruments and/or in the case of the above example, may use that money to fulfill the possible obligation that user B may owe to user A. A marketplace may determine that there are sufficient funds in an account to make a purchase and/or make a sale. A user may be prevented from making purchases, withdraws, and/or sales if there would be insufficient funds in a user's account to cover a cost and/or possible pending obligation.

A marketplace (and/or clearinghouse) may track all of user B's, for example, possible obligations. The marketplace may prevent the user from spending, withdrawing, and/or otherwise possibly obligating herself beyond the money in her account. For example, if user B's account, after receiving the 9000 dollar purchase price from user A has $10,000, then user B may be prevented from withdrawing money. User B's possible liability to user A is $10000 (i.e. 100 contracts with $100 par value). Because a withdrawal of money from the account might leave user B unable to pay user A, the marketplace may prevent such transaction unless user B increases a balance in her account.

It should be recognized that while some examples are given in terms of a line parameter from an expert that other embodiments may not be so limited. For example, some embodiments may include a straight participant to participant contest without any line. It should also be recognized that while some embodiments are given in terms of sports or head to head contests with points, that other embodiments may include any live events. For example, an American Idol winner may be the subject of a contract. The contract may win or lose based on if the contestant that defines the contract (or any of a group of contestants) wins or loses the American Idol competition. Though, in other implementations, such a contract may include a line based on a number of votes received by a contestant (e.g., contestant A will lose by less than 500 votes, contestant B will win by at least 1000 votes, etc.).

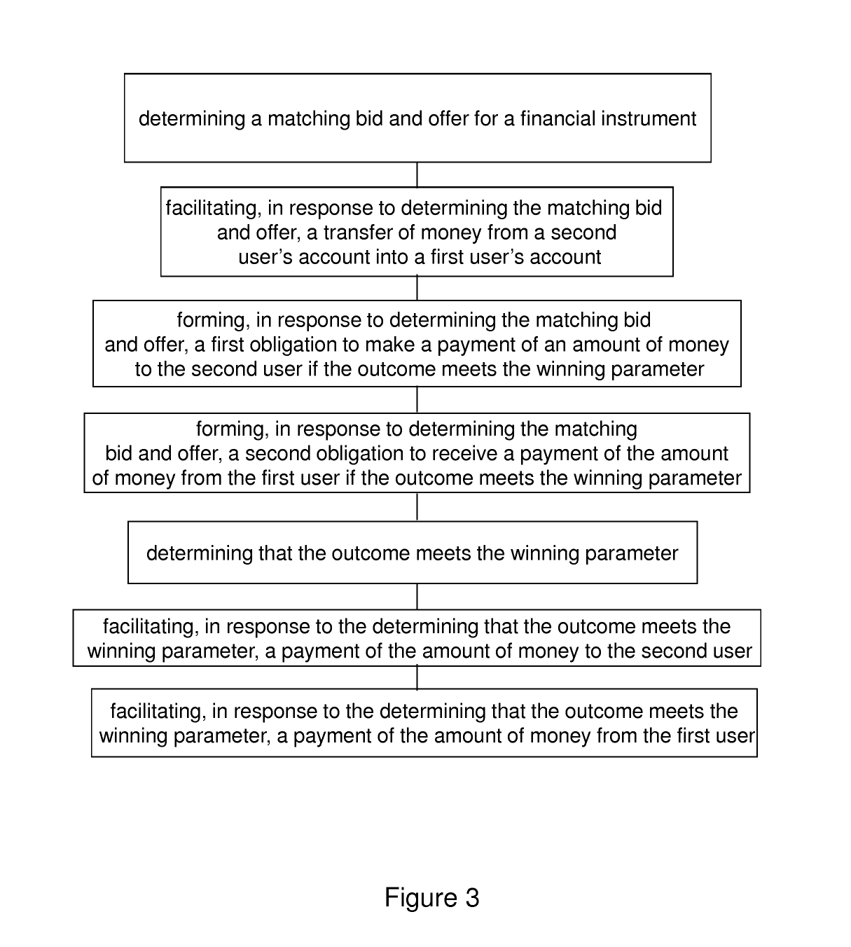

FIG. 3 illustrates an example process that may be performed in some embodiments. Such a process may be performed by one or more elements of a trading apparatus. For example, such a process may be performed by an electronic clearinghouse 105. Such a process may facilitate exchange of matched orders.

As indicated, some embodiments may include determining a matching bid and offer for a financial instrument. FIG. 2 gives an example of determining matching bids and offers. Such matching may be done by a marketplace. A marketplace may transmit information identifying a matching bid and offer to a clearinghouse through an electronic network. The clearinghouse may receive such information and thereby determine that a bid and offer match. For example, an indication that user A's order to buy 100 instruments at $90 is matched against user B's order to sell 100 instruments for $90 may be received. The instrument may obligate a payment to user A of $100 per instrument if participant A wins a contest. Information received may identify a financial instrument, a price, a quantity, and users to a trade. A clearinghouse may also receive money such as money to cover a purchase form user A's account from the marketplace.

As indicated, some embodiments may include facilitating, in response to determining the matching bid and offer, a transfer of money from a second user's account into a first user's account. Such facilitating may include actually making a transfer of money between accounts, directing another to transfer money, transferring money to a marketplace with an indication of where it should go, and so on. For example, the clearinghouse may transfer $9000 (or less if a commission is taken) to the marketplace with an indication to deposit it into user B's account as compensation for the sale.

In some embodiments, this transfer may be done in each instance. In some embodiments, a transfer of money may only be done in some instances. For example, a clearinghouse may keep such funds until an obligation outcome is determined. If an obligation is due, for example, to user A, then the funds may be used to fill that obligation. If no obligation becomes due, then the funds may be transferred to user B.

As indicated, some embodiments may include forming, in response to determining the matching bid and offer, a first obligation to make a payment of an amount of money to the second user if the outcome meets the winning parameter. Forming such an obligation may include entering such an obligation into a data structure of the clearinghouse. For example, a user may have agreed to give the clearinghouse authority to enter into obligations on her behalf. When the matching orders are identified to the clearinghouse, the clearinghouse may take any action, such as recording an agreed to obligation embodied in the trade in a database that tracks obligations. In the example of user's A and user's B exchange, an obligation may be formed indicating that the clearinghouse will pay user A $10,000 (i.e., par value times number of contracts) if participant A wins the competition.

As indicated, some embodiments may include forming, in response to determining the matching bid and offer, a second obligation to receive a payment of the amount of money from the first user if the outcome meets the winning parameter. Forming such an obligation may include entering such an obligation into a data structure of the clearinghouse. For example, a user may have agreed to give the clearinghouse authority to enter into obligations on her behalf. When the matching orders are identified to the clearinghouse, the clearinghouse may take any action, such as recording an agreed to obligation embodied in the trade in a database that tracks obligations. In the example of user's A and user's B exchange, an obligation may be formed indicating that the clearinghouse will be owed $10,000 (i.e., par value*number of contracts) if participant A does not win the competition.

As indicated, some embodiments may include determining that the outcome meets the winning parameter. A clearinghouse may determine from the financial instrument the winning parameter as discussed above. The clearinghouse may determine an outcome of an event on which a financial instrument is based. For example, the clearinghouse may receive information from an event information source that identifies outcome information. The clearinghouse may compare the wining parameter(s) of the financial instrument to the event outcome(s) to demine if the event outcome(s) match the winning parameter (s). For example, in the user A and user B example, the clearinghouse may determine if participant A won thereby meeting the winning parameters. In other embodiments there may be a line or other one or more parameters that may be met (together and/or separately in any combination) for a win.

As indicated, some embodiments may include facilitating, in response to the determining that the outcome meets the winning parameter, a payment of the amount of money to the second user. An amount of money equal to a number of contracts times a par value of the contracts may be made as a payment to the second user from the clearinghouse. Making such a payment may include transferring money into an account of the second user directly and/or through the marketplace. For example, is participant A wins the game in our example, then $10,000 might be transferred from the clearinghouse to the marketplace with an indication to place that money in user A's account. A marketplace may receive such information and funds transfer and proceed to adjust user A's account balance. In some embodiments, the transferred and/or deposited amount may be smaller because a commission may be taken by the clearinghouse and/or marketplace. This action may fulfill an obligation that the clearinghouse and second user formed.

As indicated, some embodiments may include facilitating, in response to the determining that the outcome meets the winning parameter, a payment of the amount of money from the first user. An amount of money equal to a number of contracts times a par value of the contracts may be made as a payment to the clearinghouse from the first user. Making such a payment may include transferring money from an account of the second user directly and/or through the marketplace. For example, is participant A wins the game in our example, then $10,000 might be transferred from an account of user B's at the marketplace to the clearinghouse. A marketplace may receive information indicating that such a transfer should occur and proceed to adjust user B's account balance and transfer the money to the clearinghouse. In some embodiments, the transferred and/or deposited amount may be different than the $10,000 because a commission may be taken by the clearinghouse and/or marketplace. This action may fulfill an obligation that the clearinghouse and first user formed.

It should be recognized that the examples of transferring money using a clearinghouse and marketplace are non-limiting examples only. In some embodiments, some money may remain at the clearinghouse until an obligation fulfillment occurs rather than being transferred to an account at a marketplace. For example, the 9,000 dollars paid for the 100 contracts may stay with the clearinghouse until the outcome is determined. In such an embodiment, the clearinghouse may use that 9000 and an additional 1000 to pay user A. The clearinghouse may also transfer an additional $1000 from user B rather than the entire $10,000. As yet another example, some embodiments may not include a separate clearinghouse and marketplace so the money transferring between the two may not occur. In still other embodiments, a clearinghouse may have an account at the marketplace. Money transfers to and from the clearinghouse may take place by putting money into or taking money out of that account.

It should also be recognized that this example process is given in terms of a winning outcome for a purchaser of a financial instrument. In some situations, a purchaser may end up on the losing side. In such a situation, the obligations entered into by the clearinghouse may not be triggered and no further money may be transferred. A clearinghouse may communicate to a marketplace that money that may have been frozen in a seller's account should be unfrozen in response to such an event outcome being determined. This may be done in implementations where a marketplace tracks risk of obligations triggering and restricts fund use. In implementations where the clearinghouse holds onto money until an outcome is determined, that money (e.g., the 9000 dollars) may be transferred to the selling user (e.g., user B).

In some embodiments, a cancelation event may occur (e.g., the game may not take place because of some unexpected reason). In such a situation, money may be returned to the purchaser from the seller and obligations may be canceled.

Below is a possible example implementation of a fantasy sports financial instrument being traded. A marketplace may receive a score expectation (e.g., from an expert) for a fantasy football team made up of a quarterback from one real life team, a linebacker from another real life team, and a defense from a third real life team. The score expectation may be 20 fantasy points. The fantasy tem may have been requested by the marketplace, requested by a user, created by the expert, and/or determined in any way. In response, the marketplace may list for trading a financial instrument defined as: a holder will be due $1000 if the fantasy team earns 20 or more points during football games held over the coming weekend (the time frame may vary as desired such as game, day, week, year, season, decade, minute, hour, half, quarter, tournament, etc.).

User A, who has money in an account with eh marketplace, may enter a bid of $900 to buy one of the financial instruments through a computing device. The marketplace may receive that bid, determine that the user A has sufficient funds in his account for the bid, and enter it into an order book. User B, who also has money in an account with the marketplace, may view that bid and other bids that may be in the order book for that financial instrument or other financial instruments through a computing device interface. User B may enter an offer to sell one of the financial instruments through the computing device interface. The marketplace may receive the offer and determine that user B has sufficient funds in his account to cover the potential payment obligation for selling the instrument (e.g., with the addition of the purchase price to user B's account) The marketplace, using a time and price priority matching mechanism, may determine that the bid and the offer match. The marketplace may deduct $900 from user A's account and transfer it to a clearinghouse (e.g., to an account of the clearinghouse held at the marketplace). The marketplace may freeze funds in user B's account that may be needed to pay the potential obligation (e.g., may freeze $100). The marketplace may notify the clearinghouse of the match.

In response to being notified of the match, the clearinghouse may form an obligation between itself and user A to pay user A $1000 if the fantasy team scores 20 or more points. The clearing house may form an obligation between itself and User B that obligates user B to pay the clearinghouse $1000 if the fantasy team scores 20 or more points. The clearinghouse may transfer the $900 to user B's account at the marketplace (e.g., by telling the marketplace to move money from the clearinghouse's account to User B's account). The marketplace may move that money and freeze that $900 in user B's account so that it will be available to pay the possible obligation to the clearinghouse. Effectively, the clearinghouse may have purchased the financial instrument from user B and may have sold the financial instrument to user A.

The clearinghouse may receive information indicative of whether the fantasy team scored 20 or more points. For example, the clearinghouse may receive statistic data that may be used to determine a fantasy score for the fantasy team, the clearinghouse may receive a fantasy score for the fantasy team, and so on. Such information may be received from a data source, the expert, the marketplace and/or elsewhere. This information may be used by the clearinghouse to determine what if any obligations of the financial instrument trade have been triggered. If the fantasy team scored 20 or more points, the clearinghouse may cause the marketplace to transfer $1000 into user A's account from the clearinghouse (e.g., the clearinghouse's account held at the marketplace). The clearinghouse may cause the marketplace to transfer the frozen $1000 from user B's account to the clearinghouse. On the other hand, if the team did not score the 20 or more points, the clearinghouse may cause the marketplace to unfreeze the $1000 in user B's account. If a fantasy game is canceled or invalidated, the clearinghouse may cause $900 in user B's account to be transferred to user A's account and may unfreeze the remaining frozen $100 in user B's account. In the cases of either the cancelation/invalidation and the fantasy team not scoring the 20 or more points, obligations under the financial instrument may be left triggered.

This example is given without a commission or fee being applied. But some implementations may include a fee or commission being charged to one or more of the buyer and the seller. For example, a portion of the $1000 that pay be paid to user A may instead be kept by the clearinghouse and/or marketplace, a portion of the $900 paid to user B may be kept by the clearinghouse and/or marketplace, and so on.

It should be recognized that while various examples are given in terms of full games or sets of games in a weekend, that embodiments are not so limited. Some embodiments may include outcomes that are relevant to half time of a game, quarters of a game, individual plays in a game, individual at bats, tournaments, single player games, individual parts of a tournament, individual hands of cards, individual cards being dealt, anything that may be assessed a winning parameter, and so on.

Although examples are given in terms of a buyer transferring money to a seller, it should be recognized that some embodiments may not include such an action. Rather no payment may be made to enter into some financial instruments.

For example, some financial instruments may include a two sided payment obligation set. Such as if team A wins a game user A gets a par payment and if team B wins the game, user B gets the par payment. The win may be adjusted by a line to establish a wining parameter. While a payment may be used in such a bilateral winning obligation financial instrument, it may not be used in other implementations. A payment may typically be smaller in this implementation than in implementations where there is a single winning payment to a single side.

Also, it should be recognized that while examples have been given with a purchase price that is lower than a par value and close to the par value, such examples are also non-limiting. Other embodiments may include a purchase price that is above a par value or significantly different from a par value.

In some embodiments, a financial instrument may be based on events that may be related to a game or competition but not actually part of the game or competition. For example, in some embodiments, a financial instrument may be based on an injury of a player. In other embodiments, such events may include other types of events that may affect a player's ability to play a game (e.g., arrest, sickness, being traded away, etc.). In such a case, a financial instrument may be defined by an obligation to pay a holder if the event occurs (e.g. if the player gets injured, if a player on a team gets injured, if a player in the fantasy team gets injured, etc.). These instruments may similarly to others have a variety of time frames (e.g., next game, season, week, contract of player, etc.).

In some embodiments. Such a financial instrument may be used singularly and/or in combination with one or more financial instruments. For example, a financial instrument based on team a winning may be purchased by user A. User A may also purchase a financial instrument based on the quarterback of team A getting an injury. Accordingly, the user may have taken a position that team A will win unless its quarterback is injured. This allows user A to hedge against such unfortunate possibilities.

It should be recognized that while this example of hedging is given in terms of a game, that other embodiments may include other event types. For example, in some embodiments, a performance type event may form the basis of such a hedging instrument. For example, a user may buy a financial instrument based on a health of a participant in any event (or participation of a participant in some event). For example, a user may purchase a financial instrument that pays if Lady Gaga or some other artist or player does not perform in a concert or a singing competition or other event. As another example, a user may purchase a financial instrument based on the occurrence of an event (e.g., may but an instrument that the vent will not be canceled because of weather and/or some other event). The instrument may identify the types of cancellations that pay (e.g., choice of artist may not pay but weather and injury may pay).

As yet another example, some embodiments may include a financial instrument based on weather. In such an embodiment, a location and day may have a rating based on a scale. For example a scale where 100 is a good day may be set. For example in a tropical island, a 100 may mean a mostly sunny day with warm temperature. A weather authority may set what a 100 means for each of a plurality of locations on a plurality of days (e.g., days in winter may be different from days in summer). Such setting may be based on historical data and/or desires of typical users of the location. For example, in ski locations, a good day may be a day that is good for skiing. In an outdoor football or baseball field location, a good day may be a day that is good for playing of football or baseball.

It should be recognized that such weather financial instrument may not be limited to being associated with an event or other financial instrument. Rather, for example, a user may use such a weather financial instrument to hedge against a poor vacation or other planned happening (e.g., picnic, honeymoon, vacation, wedding, etc.).

Such weather financial instrument may be day based, week based, season based, event based, and so on. Such weather financial instruments may be based on a particular area, e.g., zip code, city, state, country, area, and so on. For example, an average over a week may be used to determine an index value for the week. As another example, a high or low for a week may be used to create the index value for the week.

In some embodiments, an index may be crated for the weather in the location at the time. For example, based on the actual weather at the time, an index value may be determined. An algorithm may be established for determining a value of the index. For example, weighed may be applied to things like wind, precipitation, snow amounts, temperature, cloudiness, and so on. A measurement of each may be made and the algorithm may be applied to create an actual number.

The index determination may be compared to a target value of the weather financial instrument (e.g., 100 in the given example). If the number is below the target number, then the holder may be due a payment (e.g., because the user did not have a good day). In some embodiments there may be a range that does not trigger payments (e.g., down to 90 does not trigger a payment).

In some embodiments rather than such a one sided obligation, there may be a two sided obligation. For example, a user may owe a payment if the index exceeds some number. For example, if the user had a 115 day, then the user may owe some money to a seller.

While examples, are given with 100 being a good day, in some embodiments there may be a maximum set at 100. A target day may be lower than that. 1 may be a worst possible day and 100 may be a best possible day. It should be recognized that the particular numbers chosen are given as non-limiting examples only.

As still another example, some embodiments may include financial instruments that are based on viewer, spectator, and/or attendance numbers. For example, an audience expert may set a viewership target for an event. If fewer viewers view the event, then a payment may be due to a holder. In other embodiment, a buyer may set the target number. In still other embodiment, the instrument may pay if more viewers view rather than fewer. A clearinghouse may receive information about actual viewer number and determine what payout may be due.

Various examples are given in terms of a par payment being due or not due. It should be recognized however that such examples are given as non-limiting examples only. Some embodiments may include a differential based payment mechanism. In such embodiments, if an actual index value (e.g., weather index, fantasy point index, difference in scores in a game, etc.) increases, an amount due may also increase. There may be a variety of triggering thresholds to increase the payment due. There may be an algorithm (e.g., an equation) to determine the payment that may be due. In some embodiments in a two sided obligation situation, each side may have a differential payment mechanism. For example a sliding scale of payments may be due from one side to the other side depending on the value of an index away form a target value. A clearinghouse may determine the outcome of events and the amount due based on terms of such a financial instrument and may facilitate transfers of money accordingly.

It should be recognized that while a variety of embodiments have been described, that such embodiments are all non-limiting. Structural elements of a system are examples only. Actions of a process are examples only. Various embodiments may include same different, other, differently orders, differently arranged, and so on elements. Various elements from various implementations may be combined together in any combination as desired.

The following sections I-X provide a guide to interpreting the present application.

### I. TERMS

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “compose” and variations thereof means “to make up the constituent parts of, component of or member of”, unless expressly specified otherwise. Thus, for example, the sentence “the red widget and the blue widget compose a portfolio” means the portfolio includes the red widget and the blue widget.

The term “exclusively compose” and variations thereof means “to make up exclusively the constituent parts of, to be the only components of or to be the only members of”, unless expressly specified otherwise. Thus, for example, the sentence “the red widget and the blue widget exclusively compose a portfolio” means the portfolio consists of the red widget and the blue widget, and nothing else.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### II. DETERMINING

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. FORMS OF SENTENCES

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. DISCLOSED EXAMPLES AND TERMINOLOGY ARE NOT LIMITING

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. COMPUTING

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth®, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. CONTINUING APPLICATIONS

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. §112, PARAGRAPH 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. DISCLAIMER

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### IX. INCORPORATION BY REFERENCE

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. PROSECUTION HISTORY

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

What is claimed is:

1. A method comprising:
receiving, by a computing device, information defining a winning parameter of a contest from a contest expert;
listing, by the computing device, a financial instrument that gives a holder of the financial instrument a right to a payment based on an outcome the contest and the winning parameter;
receiving, by the computing device, an offer to sell the financial instrument at a first price;
receiving, by the computing device, a bid to buy the financial instrument at the first price;
matching, by the computing device and in response to receiving the bid for the first price and receiving the offer for the first price, the offer and the bid; and
facilitating, by the computing device and in response to matching the bid and the offer, a trade that fulfills at last a part of each of the bid and the offer.

2. The method of claim 1, in which the contest includes a fantasy sports game.

3. The method of claim 1, in which the computing device includes an electronic marketplace.

4. The method of claim 1, in which facilitating the trade includes controlling a clearinghouse to make the trade.

5. The method of claim 1, in which the method comprises:
determining, by a second computing device, the matching bid and offer for the financial instrument;
facilitating, by the second computing device and in response to determining the matching bid and offer, a transfer of money from the second user's account into the first user's account;
forming, by the second computing device and in response to determining the matching bid and offer, a first obligation to make a payment of an amount of money to the second user if the outcome of the contest meets the winning parameter;
forming, by the second computing device and in response to determining the matching bid and offer, a second obligation to receive a payment of the amount of money from the first user if the outcome meets the winning parameter;
determining, by the second computing device, that the outcome meets the winning parameter;
facilitating, by the second computing device and in response to the determining that the outcome meets the winning parameter, a payment of the amount of money to the second user; and
facilitating, by the second computing device and in response to the determining that the outcome meets the winning parameter, a payment of the amount of money from the first user.

6. The method of claim 1, in which the winning parameter includes a line.

7. A method comprising:
determining, by a computing device, a matching bid and offer for a financial instrument;
facilitating, by the computing device and in response to determining the matching bid and offer, a transfer of money from a second user's account into a first user's account;
forming, by the computing device and in response to determining the matching bid and offer, a first obligation to make a payment of an amount of money to the second user if the outcome of a contest meets a winning parameter set by an expert;
forming, by the computing device and in response to determining the matching bid and offer, a second obligation to receive a payment of the amount of money from the first user if the outcome meets the winning parameter;
determining, by the computing device, that the outcome meets the winning parameter;
facilitating, by the computing device and in response to the determining that the outcome meets the winning parameter, a payment of the amount of money to the second user; and
facilitating, by the computing device and in response to the determining that the outcome meets the winning parameter, a payment of the amount of money from the first user.

8. The method of claim 7, in which the computing device includes an electronic clearing house.

9. The method of claim 7, in which the contest includes a fantasy sports game.

10. The method of claim 7, in which the winning parameter includes a line.

11. The method of claim 7, in which determining the matching bid and offer includes receiving the matching bid and offer from an electronic marketplace.

12. The method of claim 7, in which the method comprises:
receiving, by a second computing device, information defining the winning parameter of the contest from the contest expert;
listing, by the second computing device, the financial instrument, in which the financial instrument gives a holder of the financial instrument a right to a payment based on an outcome the contest and the winning parameter;
receiving, by the second computing device, an offer to sell the financial instrument at a first price;
receiving, by the second computing device, a bid to buy the financial instrument at the first price;
matching, by the second computing device and in response to receiving the bid for the first price and receiving the offer for the first price, the offer and the bid; and
facilitating, by the computing device and in response to matching the bid and the offer, a trade that fulfills at last a part of each of the bid and the offer.

13. An apparatus comprising: a computing device and a non-transitory medium having stored thereon a plurality of instructions that when executed by the computing device cause the apparatus to:
receive information defining a winning parameter of a contest from a contest expert;
list a financial instrument that gives a holder of the financial instrument a right to a payment based on an outcome the contest and the winning parameter;
receive an offer to sell the financial instrument at a first price;
receive a bid to buy the financial instrument at the first price;
match, in response to receiving the bid for the first price and receiving the offer for the first price, the offer and the bid; and
facilitate, in response to matching the bid and the offer, a trade that fulfills at last a part of each of the bid and the offer.

14. An apparatus comprising: a computing device and a non-transitory medium having stored thereon a plurality of instructions that when executed by the computing device cause the apparatus to:
determine a matching bid and offer for a financial instrument;
facilitate, in response to determining the matching bid and offer, a transfer of money from a second user's account into a first user's account;
form, in response to determining the matching bid and offer, a first obligation to make a payment of an amount of money to the second user if the outcome of a contest meets a winning parameter set by an expert;
form, in response to determining the matching bid and offer, a second obligation to receive a payment of the amount of money from the first user if the outcome meets the winning parameter;
determine that the outcome meets the winning parameter;
facilitate, in response to the determining that the outcome meets the winning parameter, a payment of the amount of money to the second user; and
facilitating, by the computing device and in response to the determining that the outcome meets the winning parameter, a payment of the amount of money from the first user.
